(19) United States
(12) Patent Application Publication
(10) Pub. No.: US 2026/0320473 A1
(43) Pub. Date: Oct. 15, 2026

(54) SYSTEM, METHOD, AND MEDIUM TO GENERATE SYNTHETIC DATA WITH AUTOMATIC DEPENDENCY PARSER REINDEXING FOR MACHINE LEARNING TRAINING DATASET

(71) Applicant: Verizon Patent and Licensing Inc., Basking Ridge, NJ (US)

(72) Inventors: Magesh Koteeswaran, Chennai (IN); Suresh Chandrasekaran, Chennai (IN)

(21) Appl. No.: 19/056,958

(22) Filed: Feb. 19, 2025

(51) Int. Cl. G06N 20/00; G06F 40/284

(52) U.S. Cl. CPC G06N 20/00; G06F 40/284

(57) ABSTRACT

A method, a device, and a non-transitory computer-readable storage medium are described in relation to a synthetic data generation and reindexing service. The synthetic data generation and reindexing service may include a structured textual schema that enables configuration of combining and permuting sample statements for synthetic data generation, as well as prevent unbiased synthetic data based on the structured textual schema and statistical sampling of the sample data. The synthetic data generation and reindexing service may enable the generation of complex synthetic statements and corresponding dependency indexes that afford robust potential for training of models.

### BACKGROUND

Synthetic data is artificially generated to simulate real-word data and may be used to train models, such as machine learning (ML) models. Typically, synthetic data may be generated using algorithms.

### BRIEF DESCRIPTION OF THE DRAWINGS

FIG. 1 is a diagram illustrating an exemplary environment in which an exemplary embodiment of a synthetic data generation for conversational models and dependency reindexing service may be implemented;

FIGS. 2A-2D are diagrams illustrating an exemplary process of an exemplary embodiment of the synthetic data generation for conversational models and dependency reindexing service;

FIG. 3 is a diagram illustrating exemplary components of a device that may correspond to one or more of the devices illustrated and described herein;

FIG. 4 is a flow diagram illustrating an exemplary process of an exemplary embodiment of the synthetic data generation for conversational models and dependency reindexing service; and

FIG. 5 is another flow diagram illustrating another exemplary process of an exemplary embodiment of the synthetic data generation for conversational models and dependency reindexing service.

### DETAILED DESCRIPTION

The following detailed description refers to the accompanying drawings. The same reference numbers in different drawings may identify the same or similar elements. Also, the following detailed description does not limit the invention.

The application of artificial intelligence and/or machine learning (AI/ML) is gradually becoming more prevalent in various industries. In contrast to real-world data, synthetic data may be used as a stand-in for test data sets of production data or operational data to enable the validation of mathematical models and to train AI models. Synthetic data may be generated in two main ways, such as non-AI data simulation, which may include using test-data management tools, and AI-generated synthetic data, which may be structured or unstructured.

The generation of synthetic data can address two key problems, namely data scarcity and privacy concerns. As such, the generation of synthetic data may provide copious amounts of training data without the need for limited or sensitive real-world data. For example, synthetic data may augment existing datasets, create new datasets, or simulate unique scenarios.

Synthetic data may be generated using various approaches, such as statistical distribution, agent-based modeling, and neural network techniques. For example, a statistical distribution method may include analyzing statistical properties of real data, such as mean, variance, and distribution type. An algorithm may generate new data points that follow or adhere to the same statistical patterns. According to another example, an agent-based modeling method may include analyzing and mapping the behavior of real data. An algorithm, such as an iterative proportional fitting (IPF) algorithm or a combinatorial optimization algorithm may create an agent that generates emergent patterns of synthetic data in which physical laws, behavioral rules, or statistical assumptions may form the basis of a model. According to yet another example, a neural network method may use a variational auto-encoder (VAE) or a Generative Adversarial Network (GAN) to generate synthetic data. The type of approach for generating synthetic data may depend on the type of data needed, the desired outcome, and the computational resources that are available.

The generation of synthetic data, however, still presents certain challenges. For example, synthetic data may not capture the complexity of real-world datasets, and can potentially omit vital details or relationships needed for accurate predictions. For example, the models used in neural network and agent-based modeling approaches may not adequately align with conversational models that pertain to a certain context, verbiage used and meanings thereof, dependencies, and the like. For example, the use of the word “plan” in a sample statement associated with common parlance would be afforded a different meaning, dependency, etc., for synthetic data generation purposes, compared to the use of the word “plan” in a sample statement between a customer and a service provider. In this regard, the attributes associated with key words or label types within real-world sample data may significantly impact the quality of synthetic data that may be generated.

Additionally, for example, the sampling of real-world data, which may be used to generate synthetic data, may suffer from data distribution bias due to the inherent distribution properties of the real-world data. As a consequence, neural network techniques and agent-based modeling may be subject to data distribution bias, inaccurate data, higher data noise, inconsistency, lack of accuracy, lack of realism, inability for complex data creation, among other issues.

As a part of model training, the input to the model may include synthetic data and dependency parsing data associated with the synthetic data. For example, the dependency parsing data may provide information regarding the relationship between different words (e.g., of a statement) and their syntactic roles included in the synthetic data. Typically, the dependency parsing data is structurally represented by an array of numbers (e.g., [0, 0, 1, 2, 3] or another series of numbers) in which the number of key tags, entities, or labels within the statement are accounted for, as well as their relationships to each other including a “root” word of the statement. According to an exemplary approach, the dependency parsing data for a statement may be implemented as a dependency tree, which includes a “root” word, which may show the relationship, structure, hierarchy, and the like between the words in the sentence.

For complex statements, however, the conventional representation for the dependency index suffers from inaccuracies because the complex statement may include two or more “root”′ words. For example, the statement “I would like to add an iPhone with plan A and also please upgrade my Samsung S22 to a Samsung S24” may include two “root” words. According to this example, “root” words are implemented as verbs or an exemplary label type, such as “action”. Based on such an implementation, “add” and “upgrade” may be considered label type values for the label type “action” along with key words or label type values to form an array, such as [0,0,1, 2, 0, 0, 1, 2], where “0,0” indicates “add” as a “root” and a key word value, “1” for the key word value “iPhone”, “2” for the key word value “plan A”, “0,0” indicates “upgrade” as a “root” and a key word value, “1” as key word value Samsung S22”, and “2” as keyword value “Samsung 24”. The numbers included in the array also indicate dependencies, such as “1” being dependent on “0 ” (e.g., “line one” being dependent on “upgrade”), “2” dependent on “1”, etc. However, in this case, the number of key tags or label types is lost because the second “root” word resets the counting of the key tags or label types relative to that referent, which is not permissible. As such, the generation and use of complex statements in synthetic data for model training may be prohibitive due to the errors in the dependency parsing data. Additionally, for large data sets, manual intervention to correct dependency parsing data may be time and cost prohibitive.

According to exemplary embodiments, a synthetic data generation for conversational models and dependency reindexing service (also referred to as a “synthetic data generation and reindexing service,” “synthetic data generation service,” “reindexing service,” “dependency indexing service,” and “indexing service”) is described. According to an exemplary embodiment, the synthetic data generation service may generate synthetic data for conversational models. According to various exemplary embodiments, the models may be implemented as an AI model, an ML model, a deep learning (DL) model, a neural network (NN) model, a large language model (LLM), or another type of model.

According to an exemplary embodiment, the synthetic data generation and reindexing service may generate synthetic data and dependency parsing data, as described herein, based on real-world data and dependency parsing data. According to some exemplary embodiments, the real-world data (also referred to as “sample data”) may be implemented as simple statements and not complex statements, as described herein.

According to an exemplary embodiment, the sample data may include metadata. The metadata may indicate label types, label type values, expressions, expression types, and other types of textual elements, as described herein. According to an exemplary embodiment, the sample data may be conversational data, such as one person speaking to another person. According to an exemplary embodiment, the sample data may be context-specific in which label types, label type values, phrases, dependencies, and other textual elements may be impacted. According to an exemplary embodiment, the synthetic data generation service may enable a user to configure the sample data in a manner that provides for the generation of synthetic data that accounts for such context and provides synthetic data that is more representative of real-world data, has a higher data precision and accuracy, minimal noise, and greater consistency.

According to an exemplary embodiment, the synthetic data generation service may include analyzing the sample data and generating partially complete simple and complex synthetic statements that each may include a label type, as described herein. According to an exemplary embodiment, the synthetic data generation service may subsequently select label type values for the label type based on stratified and random sampling of the label type values included in the sample data. In this way, the synthetic data generation service may form and generate simple and complex synthetic statements that are complete and data unbiased. According to an exemplary embodiment, the synthetic data generation service may replace the label type with the label type values to form the complete simple and complex synthetic statements, as described herein.

According to an exemplary embodiment, the synthetic data generation service may enable a user to configure the selection of sample data statements as a basis for combining and permutating the sample data to form the synthetic data.

According to an exemplary embodiment, the reindexing service may include the generation of dependency parsing data for the generated synthetic data, as described herein. According to an exemplary embodiment, the generation of the dependency parsing data may include an automated dependency indexing or reindexing of the dependency parsing data, as described herein. According to an exemplary embodiment, for complex statements, which may include two or more label types that have been designated as “root” label types, may be reindexed, as described herein. For example, the reindexing may include preserving the counting of the label types relative to the first “root” label type as well as preserving the indicating of a second, third, or more “root” label type.

In view of the foregoing, the synthetic data generation and reindexing service may improve the generation of synthetic data and dependency indexing for model training. For example, the synthetic data generation and reindexing service may generate unbiased, real world, and accurate synthetic data using statistical methods based on the real-world data and the structured elements (e.g., label types, label type values, etc.) directed to context-specific applications, as described herein. The synthetic data generation and reindexing service may further enable the generation and use of complex synthetic statements, which may enhance the depth and quality of synthetic data for training for models, as described. The synthetic data generation and reindexing service may improve the generation and use of dependency parsing data based on the reindexing of such data. In this way, the generation of synthetic data and corresponding dependency parsing data may improve model training and the use of resultant trained models in various applications and environments.

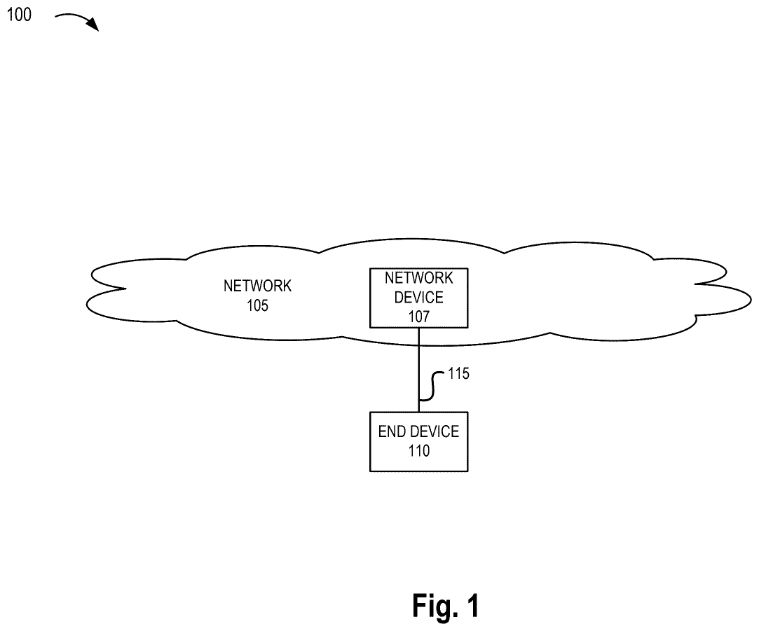

FIG. 1 is a diagram illustrating an exemplary environment 100 in which an exemplary embodiment of the synthetic data generation and reindexing service may be implemented. As illustrated, environment 100 may include a network 105. Network 105 may include a network device 107. Environment 100 may include an end device 110.

Environment 100 may include a communication link 115 between network 105 and network device 107 and/or between end device 110 and network 105 and/or network device 107. A communicative connection via communication link 115 may be direct or indirect. For example, an indirect connection may involve an intermediary device and/or an intermediary network not illustrated in FIG. 1. A direct connection may not involve an intermediary device and/or an intermediary network. The number and arrangement of communication link 115 illustrated in environment 100 are exemplary. Communication link 115 may be wired, wireless, and/or optical.

Network 105 may include one or multiple networks of one or multiple types and/or technologies. For example, network 105 may include a wireless network, a wired network, and/or an optical network. Network 105 may be implemented to include a local area network (LAN), a wide area network (WAN), a radio access network (RAN), a core network, a service provider network, a network management network, a private network, a public network, or another type of network that may support access and/or use of the synthetic data generation and reindexing service.

Network device 107 may include a network device that provides the synthetic data generation and reindexing service, in whole or in part, as described herein. For example, network device 107 may include data pre-processing logic, stratified and random sampling logic, synthetic data generation logic, and dependency parser and reindexing logic, as described herein.

Network device 107 may include other logic that provides a function, a step, or a process of the synthetic data generation and reindexing service, as described herein. According to some exemplary embodiments, network device 107 may provide the synthetic data generation and reindexing service, in whole or in part, in an automated manner. Network device 107 is described further below.

End device 110 may include a device that provides the synthetic data generation and reindexing service, in whole or in part, as described herein. End device 110 may include a component that provides a function, a step, or a process of the synthetic data generation and reindexing service, as described herein. For example, the component may be similar to that of network device 107, as described herein. According to some exemplary embodiments, end device 110 may provide the synthetic data generation and reindexing service, in whole or in part, in an automated manner. According to various exemplary embodiments, end device 110 may be implemented as a device operated by a user or a device not operated by a user. For example, end device 110 may be implemented as a computer (e.g., desktop, laptop, or the like), a workstation, or a terminal.

Communication link 115 may include a wireless, a wired, and/or an optical link. Communication link 115 may support a communicative connection, a communication session, exchange of data, and the like.

According to various exemplary embodiments, the synthetic data generation and reindexing service may be implemented entirely by end device 110, entirely by network device 107, or collaboratively by end device 110 and network device 107. In view of these different embodiments, environment 100 may be different than that depicted in FIG. 1. For example, according to other exemplary embodiments, environment 100 may not include network 105, network device 107, and communication link 115, or alternatively, environment 100 may not include end device 110 and communication link 115. According to still other embodiments, environment 100 may be implemented to include multiple network devices 107 in which network devices 107 may collaboratively perform a process or a step of the process associated with the synthetic data generation and reindexing service. In this regard, the number and arrangement of network device 107 and end device 110 are exemplary. For purposes of description, end device 110 is not considered a network device.

A network device, a network element, or a network function (referred to herein simply as a network device) may be implemented according to one or multiple network architectures, such as a client device, a server device, a peer device, a proxy device, and/or a virtualized network device. Additionally, the network device may be implemented according to various computing architectures, such as centralized, distributed, and/or another type of computing architecture. The network device may also be implemented as a network platform, a network system, a network service, or the like.

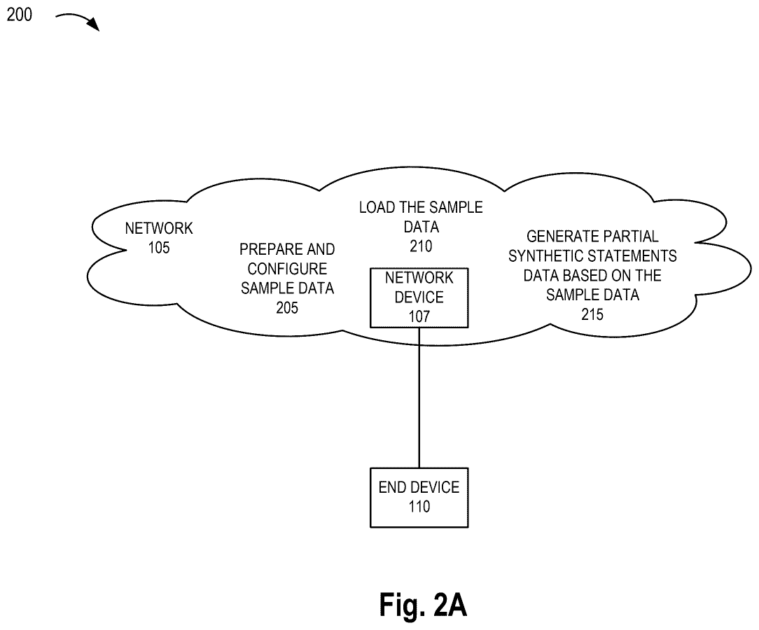

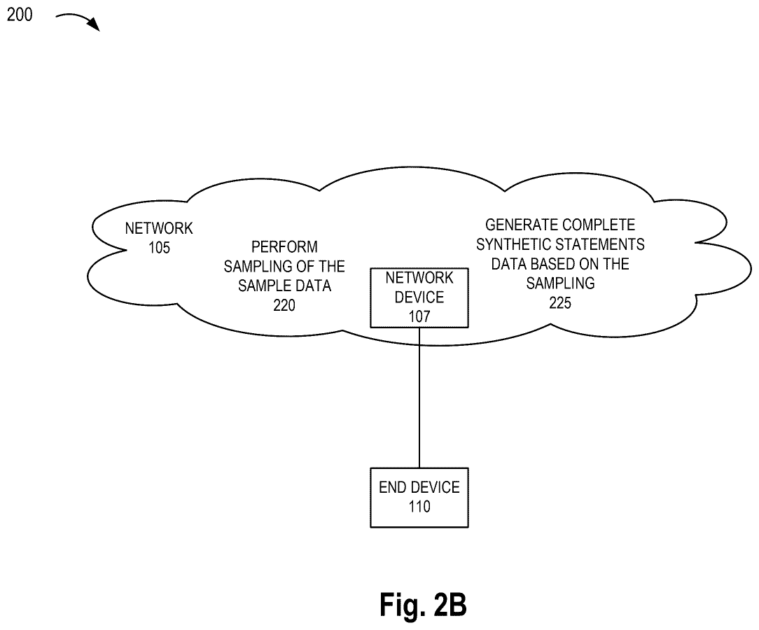

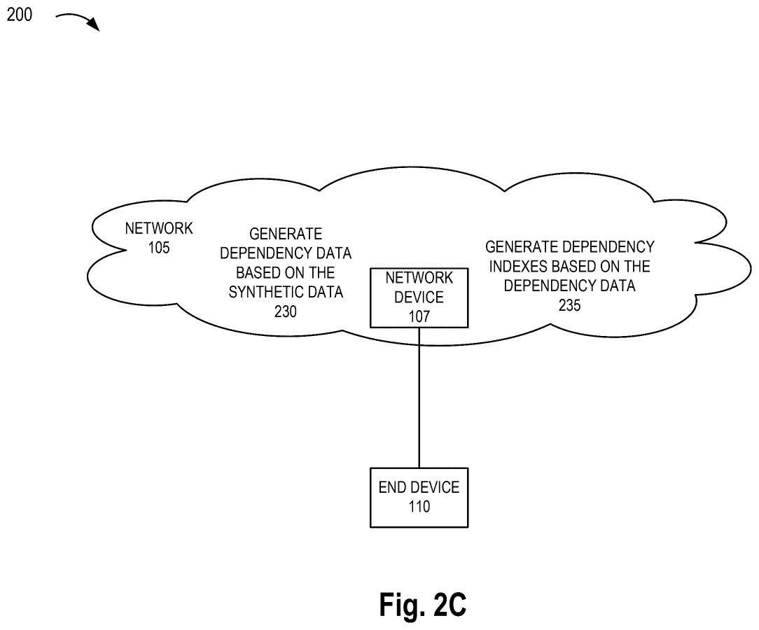

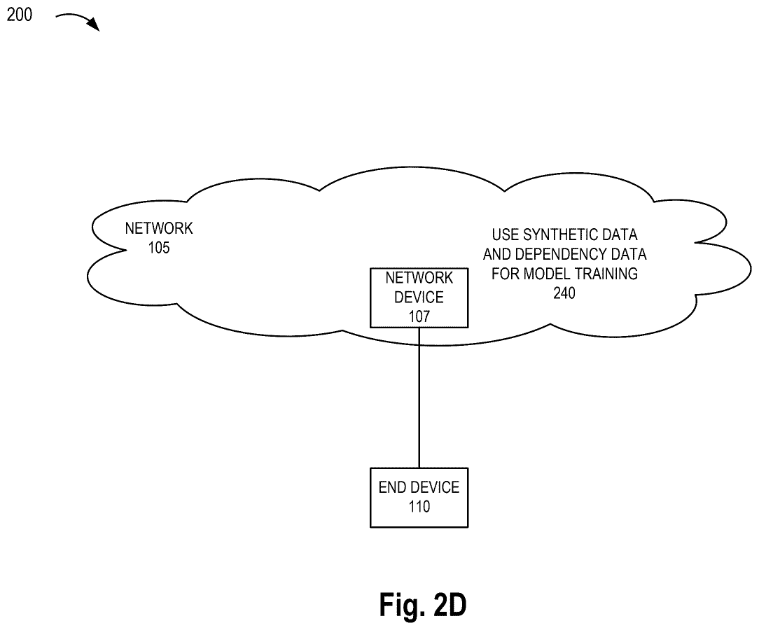

FIGS. 2A-2D are diagrams illustrating an exemplary process 200 of an exemplary embodiment of the synthetic data generation and reindexing service. According to this exemplary embodiment, process 200 may be implemented by network device 107 and end device 110. According to other exemplary embodiments, as previously described, process 200 may be implemented solely by end device 110 or network device 107.

Referring to FIG. 2A, as illustrated, process 200 may include preparing and configuring the sample data 205. According to this example, a user (not illustrated) of end device 110 may participate in this step. For example, the user may prepare and configure the sample data at network device 107 via end device 130. According to other examples, the sample data may be prepared and configured in a different manner.

According to an exemplary embodiment, the sample data may include real-world statements, such as conversational data, as described herein. The sample data may include sample statements, expressions and phrases, and metadata. The metadata may include label types, label type values, and types (e.g., prefix, post-fix, conjunction, etc.) pertaining to the sample statements, expressions, and phrases-examples of which are described herein.

According to an exemplary embodiment, the sample data may be context-specific in which the context impacts the content of the sample data. For example, the sample data may pertain to statements made by users of a service provider, such as a wireless service provider, a wireless network operator, or the like, where the verbiage used may impact various facets of the sample data due to such context. By way of further example, words present in the sample statements, such as “plan,” or “feature” or a series of numbers (e.g., the last 4 numbers pertaining to a mobile phone number) may be afforded a special meaning or considered notable for textual labeling. In this regard, the meaning attributable to a word, a phrase, expression, and other facets of the sample data relative to the same verbiage that may be used in other contexts of a conversation may impact the various facets of the sample data. According to such circumstances, the sample data may include other types of data, such as catalog data and/or proprietary data that may be used to elicit specific datapoints, such as label types, label type values, expressions, etc., that may otherwise not be present in typical synthetic data generation situations.

For the sake of description purposes only, exemplary textual elements of exemplary sample data are provided. The label types, the label type values, the dependency index (DPindex) values, expressions, and types shown are configurable and not to be considered limiting.

| Sample Statement | DPindex | Label Type: Action |
|---|---|---|
| Add a new line with $device$ | Root, 0, 1 | Add |
| Upgrade $device$ to $device$ | Root, 0, 1, 2 | Upgrade |
| Change plan to $plan$ | Root, 0, 1 | Change |

| Expressions | Type |
|---|---|
| I would like to | prefix |
| and also | post-fix |
| create a postpay quote | prefix |
| and | conjunction |

As illustrated, the exemplary sample statements may include a label type (also referred to as a label type designator), which for these examples are represented as “$device$” or $plan$.” According to other examples, the label types may be different according to a particular label type schema. As further illustrated, each of the sample statements may include a root word. For example, the root word may be “add,” “upgrade”, or “change” which may be a label type value for the label type, such as “action.”

As described herein, according to an exemplary embodiment of process 200, the user may configure network device 107 regarding how the sample statements may be combined by way of referencing a label type value or a label type for purposes of combining or permuting sample statements associated with the label type value or label type. For example, the user may configure network device 107 to combine or permute every “add” statement with every “'upgrade” statement. In this way, the user may configure how the sample statements are used to generate complex synthetic statements. The user may further provide configuration data to enable the generation of simple synthetic statements, such as indicating “type” of expression, phrase, etc., as described additionally below.

For purposes of description, a complex statement may include two or more root words. The complex statement may include one or multiple conjunctions, such as “and,” “or,” “but”, “also,” etc., which may enable the joining of two or more sample statements, expressions or phrases, clauses, and so forth. A simple synthetic statement may include use of expressions, phrases, etc., that are added to the simple sample statement. In this way, the user may provide configuration data that configures the generation of partial or complete synthetic statements, as described herein.

According to this example, sample statements may be correlated to dependency data, which includes dependency indexes, as described herein. For example, the dependency index may include a structured representation of the label types, the number of label types, and their relationship to each other including a “root” word of the statement. According to an exemplary embodiment, the dependency index may be implemented as an array of numbers or another suitable data structure that may represent such features.

As further described, the sample data may include expressions, phrases, prepositions, clauses, special purpose words (e.g., conjunctions, etc.), and the like which may be tagged or correlated with labels. According to various exemplary implementations, the labels may indicate a positional usage (e.g., relative to a sample statement) for constructing a synthetic statement (e.g., simple, complex), such as a prefix (e.g., in which the expression is placed before the sample statement) or a postfix (e.g., in which the expression is place after the sample statement), or may indicate a functional aspect (e.g., conjunction). The user may configure network device 107 to combine or permute distinct types of statements, as described herein, with expressions, phrases, clauses, special purpose words, etc., based on their associated “type” label, proper grammar, etc.

As further illustrated in FIG. 2A, process 200 may include loading the sample data 210. For example, the sample data and configuration data may be provided to network device 107 for synthetic data generation. In response, network device 107 may generate partial synthetic statements data based on the sample data 215. For example, network device 107 may combine or permute the sample statements along with expressions, phrases, special words, etc., according to the configuration data. The generation of partial synthetic statements may yield partial simple synthetic statements and partial complex synthetic statements. The partial synthetic statements may include label type designators, as described herein.

For the sake of description purposes only, an exemplary partial complex synthetic statement is provided.

### Partial Complex Synthetic Statement

I would like to add $device$ and $device$ to my account and upgrade line one to $device$.

As illustrated, “I would like to” may constitute an expression with a “prefix” label, “add $device$ to $device”′ may constitute a sample statement, “to my account” may constitute an expression with a “postfix” label, “and” may constitute a special purpose word (e.g., conjunction”, and “upgrade line one to $device$ may constitute a sample statement.

Referring to FIG. 2B, in response to the generation of partial synthetic statements, network device 107 may perform a sampling of the sample data 220. For example, with reference to the partial complex synthetic statement above, network device 107 may perform a sampling of label type values for the label type $device$. According to an exemplary embodiment, network device 107 may use a stratified sampling algorithm that samples the sample data. In this way, the synthetic data generation service may prevent or minimize a biased representation of label type values for a label type of relevance and ensure the diversity, accuracy, and precision of such statement building elements, as well as minimize data noise, support complex statement structures, and so forth. According to an exemplary embodiment, network device 107 may apply a random sampling algorithm to each stratum or sub-group output by the stratified sampling algorithm to form a dataset to be used to replace the label types included in the partial synthetic statements and populate them with label type values selected from the dataset. According to an exemplary implementation, network device 107 may use proportionated stratified random sampling.

In response to the sampling procedure, network device 107 may generate complete synthetic statements data based on a result of the sampling 225. For example, network device 107 may replace each label type included in a partial synthetic statement and populate it with a label type value. As a result, network device 107 may iteratively generate a multitude of complete synthetic statements stemming from the partial synthetic statement based on the various possible label type values for a given label type.

For the sake of description purposes only, an exemplary complete complex synthetic statement is provided. The complete complex synthetic statement relates to the partial synthetic statement provided above, and corresponds to one of many possible complex synthetic statements that may be generated in view of the possible label type values for the label type $device$.

### Complete Complex Synthetic Statement

I would like to add Galaxy S21 and iPhone 15 to my account and upgrade line one to Motorola Razor Black.

Referring to FIG. 2C, in response to the generation of the complete synthetic statements, network device 107 may generate dependency data based on the synthetic data. For example, network device 107 may identify complete complex synthetic statements based on the number of root words (e.g., two or more) that may be included in a complete complex synthetic statement. For simple synthetic statements, network device 107 may not generate dependency data because the additive nature to a simple sample statement with an expression, phrase, or other word(s) may not alter the dependency index data associated with the simple sample statement from which the simple synthetic statement may be derived.

According to an exemplary embodiment, network device 107 may parse the complete complex synthetic statement to identify and cull out or select the series of label types included in the complete complex synthetic statement. By way of example, for the sake of description only, consider the following exemplary complete complex synthetic statement:

### Complete Complex Synthetic Statement

I would like to add iPhone 15 with an unlimited plan and upgrade my Galaxy S21 to a Galaxy S25.
   Network device 107 may identify the presence of two root words, such as “add” and “upgrade”, which may be label type values for a particular label type that has been designated as a root word (e.g., action) according to an exemplary sample statement schema. Network device 107 may further identify and cull out or select other label types based on the presence of their corresponding label type values.

Based on the parsing procedure, network device 107 may generate a data structure or data representative of the construction of the complete complex synthetic statement 230. For example, network device 107 may generate dependency data, such as an array or other suitable data structure that indicates the presence of root words and other label types, their relationships to one another, etc., as described herein. By way of example, for the sake of description only, consider the following exemplary dependency data for the complete complex synthetic statement mentioned above:

### Dependency Data

[Root, action, device, plan, Root, action, device, device]

According to this example, “add” may indicate a root and is associated with a label type (e.g., action), followed by the label type “device” for iPhone 15, and “plan” for “unlimited plan”, further followed by another root and label type for “action”, followed by label type device and device for Galaxy S21 and Galaxy S25, respectively.

In response to the generation of dependency data for the complete complex synthetic statements, network device 107 may generate dependency indexes 235 according to the reindexing service, as described herein. As previously described, the reindexing service may eliminate the representation of two or more root words while preserving the relational aspects of the label types relative to the root word as well as accounting for the number of label types in the complex synthetic statement. Based on the dependency indexing or reindexing procedure, network device 107 may generate dependency index data that is suitable for use for training a model. By way of example, for the sake of description only, provided below is an exemplary array that may serve as a dependency index resulting from the reindexing service, as described herein:

### Dependency Index Data

[0, 0, 1, 2, 0, 4, 5]

According to this example, “0,0” may be representative of “add” as a root word and a label type “action”; “1” may be representative of the label type “device”; “2” may be representative of the label type “plan”; “0 ” may be representative of the label type “action”, and “4” and “5” may be representative of the multiple instances of the label type “device”. As illustrated, the number of label types is preserved. For example, in contrast to an array, such as [0,0, 1, 2, 0, 0, 1, 2], which may otherwise represent the dependency data above, in which the second instance of the root word and label type (e.g., “0,0”) resets the counting of label types back to “1”, the reindexing service may eliminate this and provide that the multiple instances of the label type “device” are indicated as “4” and “5” relative to the single root word.

Referring to FIG. 2D, network device 107 may use the synthetic data and the dependency data for model training 240. For example, network device 107 may store the synthetic data and the dependency data, which is provided by the synthetic data generation and reindexing service, for use to train a model 240. According to some exemplary embodiments, network device 107 may transmit the synthetic training data to another network device (not illustrated) to enable the training of a model. According to other exemplary embodiments, network device 107 may perform training of a model based on the generated synthetic training data.

FIGS. 2A-2D illustrate an exemplary process 200 of the synthetic data generation and reindexing service, however, according to other exemplary embodiments, the synthetic data generation and reindexing service may perform additional operations, fewer operations, and/or different operations than those illustrated and described in relation to FIGS. 2A-2D.

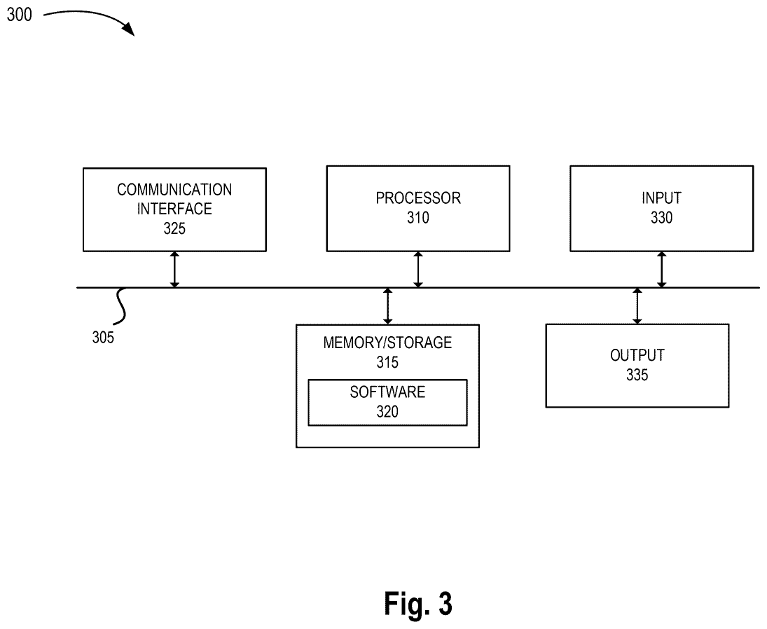

FIG. 3 is a diagram illustrating exemplary components of a device 300 that may be included in one or more of the devices described herein. For example, device 300 may correspond to network device 107 and end device 130, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, or some other type of storing medium. Memory/storage 315 may store data, software, and/or instructions related to the operation of device 300.

Software 320 includes an application or a program that provides a function and/or a process. As an example, with reference to network device 107, software 320 may include an application that, when executed by processor 310, provides a function and/or a process of the synthetic data generation and reindexing service, as described herein. According to another example, with reference to end device 130, software 320 may include an application that, when executed by processor 310, provides a function and/or a process of the synthetic data generation and reindexing service, as described herein. Software 320 may also include firmware, middleware, microcode, hardware description language (HDL), and/or another form of instruction. Software 320 may also be virtualized. Software 320 may further include an operating system (e.g., Windows, Linux, Android, proprietary, etc.), such as operating system 204. Software 320 may include libraries, algorithms, natural language processing (NLP) software, client software, server software, and the like.

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooted, or another type of state or status), using well-known virtualization technologies. For example, network device 107 or end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a function, an operation, or a process described herein. Alternatively, for example, according to other implementations, device 300 may be configured to perform a function, an operation, or a process described herein based on the execution of hardware (processor 310, etc.).

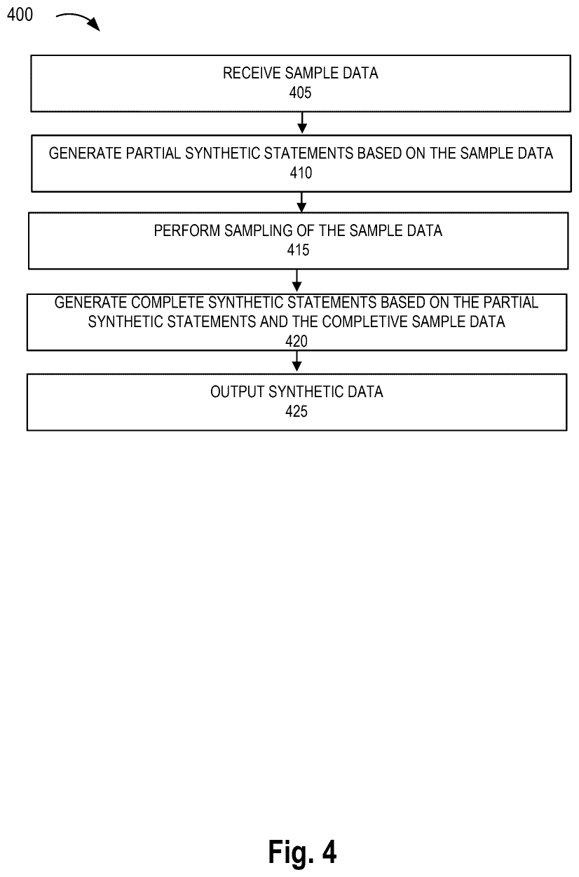

FIG. 4 is a flow diagram illustrating an exemplary process 400 of an exemplary embodiment of the synthetic data generation and reindexing service. According to various exemplary embodiments, network device 107 or end device 130, individually, or collaboratively may perform a step of process 400 or process 400 in its entirety. According to an exemplary implementation, a processor may execute software to perform a step (in whole or in part) of process 400, as described herein. Alternatively, a step (in whole or in part) may be performed by execution of only hardware. For the sake of brevity, process 400 is described as performed by network device 107. According to an exemplary embodiment, process 400 may be provided by the synthetic data generation service.

Referring to FIG. 4, in block 405, network device 107 may receive sample data. For example, the sample data may include sample statements, dependency index data, and other data (e.g., metadata, expression and phrase data, etc.), as described herein.

In block 410, network device 107 may generate partial synthetic statements based on the sample data. For example, network device 107 may combine, permute, or both sample statements with expressions, phrases, etc. according to the configuration data, as described herein. According to an exemplary embodiment, the partial synthetic statements may include label type designators (e.g., which may indicate label types according to a label type schema and configuration). For example, the label type designators may serve as a variable data instance, which may be replaced with label type values, as described herein.

In block 415, network device 107 may perform sampling of the sample data. For example, network device 107 may sample, such as stratified and random sampling of the sample data in relation to label type values pertaining to the label types, and generate a set of candidate label type values for each instance of the label type designator included in the partial synthetic statement.

In block 420, network device 107 may generate complete synthetic statements based on the partial synthetic statements and the completive sample data. For example, network device 107 may generate the complete synthetic statements based on removing each label type designator and populating (e.g., through iteration), each suitable label type value, as described herein. Network device 107 may include logic that manages the selection of label type values relative to other label type values and label type designators included in a partial synthetic statement to accommodate combinations and/or permutations that result in the highest yield of synthetic statements.

In block 425, network device 107 may store and/or output the generated synthetic data. The synthetic data may include simple and complex synthetic statements, as described herein.

FIG. 4 illustrates an exemplary process 400 of the synthetic data generation and reindexing service, however, according to other exemplary embodiments, the synthetic data generation and reindexing service may perform additional operations, fewer operations, and/or different operations than those illustrated and described in relation to FIG. 4. For example, network device 107 may train a model based on the generated synthetic data.

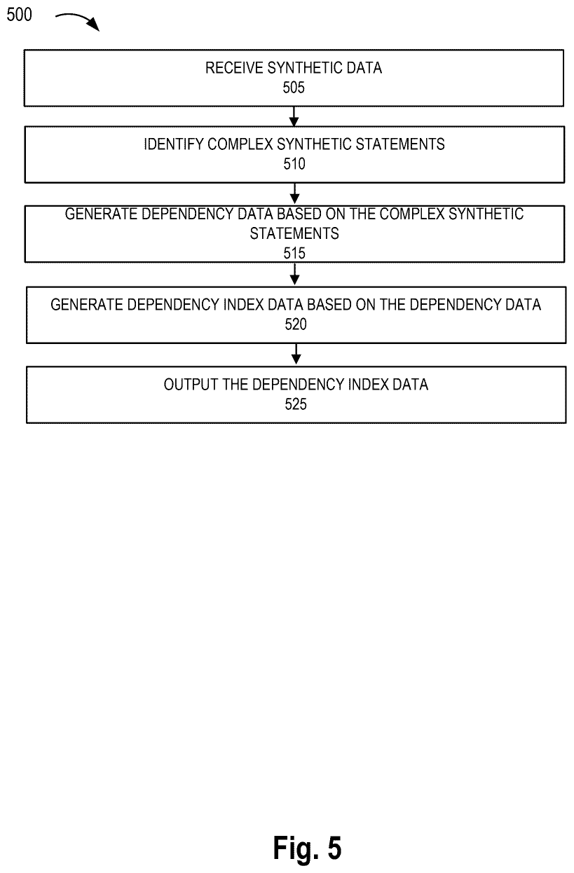

FIG. 5 is a flow diagram illustrating another exemplary process 500 of an exemplary embodiment of the synthetic data generation and reindexing service. According to various exemplary embodiments, network device 107 or end device 130, individually, or collaboratively may perform a step of process 500 or process 500 in its entirety. According to an exemplary implementation, a processor may execute software to perform a step (in whole or in part) of process 500, as described herein. Alternatively, a step (in whole or in part) may be performed by execution of only hardware. For the sake of brevity, process 500 is described as performed by network device 107. According to an exemplary embodiment, process 500 may be provided by the reindexing service.

In block 505, network device 107 may receive synthetic data. For example, the synthetic data may include simple and complex statements, as described herein.

In block 510, network device 107 may identify complex synthetic statements. For example, network device 107 may identify the complex synthetic statements, which differ from simple synthetic statements, based on the number of root words included in the synthetic statements, as described herein.

In block 515, network device 107 may generate dependency data based on the complex synthetic statements. For example, network device 107 may generate dependency data that indicates the root words, the label types, their order, etc., as described herein. By way of further example, a complex statement may yield dependency data, such as:
[Root, action, device, plan, Root, action, device, device, plan],
   in which the dependency data indicates multiple root words.

Network device 107 may also generate dependency data for simple synthetic statements in a similar manner except that the dependency data may indicate a single root word, as described herein.

In block 520, network device 107 may generate dependency index data based on the dependency data. For example, network device 107 may include eliminating the presence of multiple root indicators in the dependency data, representing the number and order of label types relative to a single root word, among other things, as described herein. By way of further example, in reference to the exemplary dependency data mentioned above, in contrast to a dependency index of [0, 0, 1, 2, 0, 0, 1, 2, 3], network device 107 may include eliminating the dual indicators for the second instance of the root word and a recounting of the number of label types relative to the first root word. As a result, network device 107 may generate a dependency index [0, 0, 1, 2, 0, 4, 5, 6] in which “0, 0 ” associated with dual indicators of the second root word are replaced with “0”, and “1, 2, 3” (which is a restart of the counting of the label types relative to the second root word) is replaced by “4, 5, 6”. In this regard, the second root word implicitly constitutes the 3^{rd} (“3”) label type relative to the first root word instance, followed by 4, 5, and 6.

Network device 107 may also generate dependency index data for the dependency data relating to simple complex statements in a manner as described herein, in which the root word is identified and the number of label types relative to the root word are represented, as well as their relationship to each.

In block 525, network device 107 may store and/or output the dependency index data, the dependency data, or both.

FIG. 5 illustrates an exemplary process 500 of the synthetic data generation and reindexing service, however, according to other exemplary embodiments, the synthetic data generation and reindexing service may perform additional operations, fewer operations, and/or different operations than those illustrated and described in relation to FIG. 5. For example, network device 107 may train a model based on the dependency data, the dependency index data, or both in combination with the synthetic data. According to an exemplary embodiment, process 500 is a continuation of process 400, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIGS. 4 and 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a device, sample data that includes sample statements, expressions, metadata, and configuration data;
generating, by the device based on the sample data, partial synthetic statements that include label type designators;
generating, by the device based on sampling of the sample data, completive sample data that includes label type values corresponding to the label type designators;
generating, by the device based on the partial synthetic statements and the completive sample data, complete synthetic statements, wherein the label type designators are removed and replaced with the label type values;
identifying, by the device, complete complex synthetic statements included in the complete synthetic statements;
generating, by the device based on the complete complex synthetic statements, dependency data;
generating, by the device based on the dependency data, dependency index data; and
using, by the device, training data, which includes the complete synthetic statements and the dependency index data, to train a model.

2. The method of claim 1, wherein the identifying comprises:
identifying, by the device, a number of root words included in each of the complete synthetic statements; and
determining, by the device based on the identifying of the number of root words, that each complete synthetic statement that includes two or more root words is a complete complex synthetic statement.

3. The method of claim 1, wherein the metadata includes data indicating label types and the label type values pertaining to words included in the sample statements.

4. The method of claim 3, wherein generating the partial synthetic statements further comprises:
generating, by the device, the partial synthetic statements based on the configuration data that indicates which sample statements are combined or permuted according to the label type values included in the sample statements.

5. The method of claim 1, wherein the sampling of the sample data comprises:
performing, by the device, stratified and random sampling of the label type values corresponding to the label type designators to which the label type values pertain.

6. The method of claim 1, wherein the dependency data indicates a relationship among different words within each of the complete complex synthetic statements including an indication of multiple root words.

7. The method of claim 6, wherein the generating of the dependency index data includes replacement of the indication of multiple root words with a single root word and a resequencing of a number of label types relative to the single root word for each complete complex synthetic statement.

8. The method of claim 1, wherein the model is an artificial intelligence (AI) model, a machine learning (ML) model, a deep learning (DL) model, or a neural network (NN) model.

9. A device comprising:
a processor, wherein the processor is configured to:
receive sample data that includes sample statements, expressions, metadata, and configuration data;
generate, based on the sample data, partial synthetic statements that include label type designators;
generate, based on sampling of the sample data, completive sample data that includes label type values corresponding to the label type designators;
generate, based on the partial synthetic statements and the completive sample data, complete synthetic statements, wherein the label type designators are removed and replaced with the label type values;
identify complete complex synthetic statements included in the complete synthetic statements;
generate, based on the complete complex synthetic statements, dependency data;
generate, based on the dependency data, dependency index data; and
use training data, which includes the complete synthetic statements and the dependency index data, to train a model.

10. The device of claim 9, wherein when identifying, the processor is further configured to:
identify a number of root words included in each of the complete synthetic statements; and
determine, based on the identification of the number of root words, that each complete synthetic statement that includes two or more root words is a complete complex synthetic statement.

11. The device of claim 9, wherein the metadata includes data indicating label types and the label type values pertaining to words included in the sample statements.

12. The device of claim 11, wherein when generating the partial synthetic statements, the processor is further configured to:
generate, the partial synthetic statements based on the configuration data that indicates which sample statements are combined or permuted according to the label type values included in the sample statements.

13. The device of claim 9, wherein when sampling the sample data, the processor is further configured to:
perform stratified and random sampling of the label type values corresponding to the label type designators to which the label type values pertain.

14. The device of claim 9, wherein the dependency data indicates a relationship among different words within each of the complete complex synthetic statements including an indication of multiple root words.

15. The device of claim 14, wherein when generating the dependency index data, the processor is further configured to:
provide replacement of the indication of multiple root words with a single root word and a resequencing of a number of label types relative to the single root word for each complete complex synthetic statement.

16. The device of claim 9, wherein the model is an artificial intelligence (AI) model, a machine learning (ML) model, a deep learning (DL) model, or a neural network (NN) model.

17. A non-transitory computer-readable storage medium storing instructions executable by a processor of a device, wherein the instructions are configured to:
receive sample data that includes sample statements, expressions, metadata, and configuration data;
generate, based on the sample data, partial synthetic statements that include label type designators;
generate, based on sampling of the sample data, completive sample data that includes label type values corresponding to the label type designators;
generate, based on the partial synthetic statements and the completive sample data, complete synthetic statements, wherein the label type designators are removed and replaced with the label type values;
identify complete complex synthetic statements included in the complete synthetic statements;
generate, based on the complete complex synthetic statements, dependency data;
generate, based on the dependency data, dependency index data; and
use training data, which includes the complete synthetic statements and the dependency index data, to train a model.

18. The non-transitory computer-readable storage medium of claim 17, wherein the instructions to identify are further configured to:
identify a number of root words included in each of the complete synthetic statements; and
determine, based on the identification of the number of root words, that each complete synthetic statement that includes two or more root words is a complete complex synthetic statement.

19. The non-transitory computer-readable storage medium of claim 17, wherein the instructions to sample further comprise instructions configured to:
perform stratified and random sampling of the label type values corresponding to the label type designators to which the label type values pertain.

20. The non-transitory computer-readable storage medium of claim 17, wherein the model is an artificial intelligence (AI) model, a machine learning (ML) model, a deep learning (DL) model, or a neural network (NN) model.
